(19) United States
(12) Patent Application Publication
(10) Pub. No.: US 2026/0344928 A1
(43) Pub. Date: Nov. 5, 2026

(54) FLUIDIC CONDUIT FOR DISPENSING HOT WATER, DISPENSING GROUP, COFFEE MACHINE, RECIRCULATION METHOD, AND METHOD FOR DISPENSING HOT WATER

(71) Applicant: ILLYCAFFE' S.P.A., Trieste (IT)

(72) Inventors: Christian BRACICH, Trieste (IT); Riccardo PIRAS, Trieste (IT); Francesco CESCUTTI, Trieste (IT); Eugenio RONCALI, Trieste (IT); Marco FERRARI, Trieste (IT)

(21) Appl. No.: 19/121,243

(22) PCT Filed: Oct. 11, 2023
(86) PCT No.: PCT/IB2023/060228

§ 371 Date: Apr. 15, 2025

(30) Foreign Application Priority Data
Oct. 18, 2022 (IT) 102022000021438

(51) Int. Cl. A47J 31/46; A47J 31/44; A47J 31/52

(52) U.S. Cl. CPC A47J 31/469; A47J 31/4421; A47J 31/461; A47J 31/465; A47J 31/468; A47J 31/5253

(57) ABSTRACT

A fluidic water conduit for dispensing hot water has a main branch for receiving water through a first water inlet opening and allowing a flow of water towards a hot water dispensing opening, a first heating device for heating the water flowing into the main branch, and a recirculation branch which originates from the main branch downstream of the first heating device and upstream of the hot water dispensing opening and which is fluidically reintroduced into the main branch upstream of the first heating device. The main branch has a collection conduit for accumulating preheated water reintroduced into the main branch by the recirculation branch and at least partially thermally conductive for allowing transmission of heat from preheated water accumulated in the collection conduit towards an environment. A dispensing group includes the fluidic water conduit.

### FIELD OF APPLICATION

The present invention relates to a fluidic conduit for dispensing hot water, a dispensing group for dispensing hot water and preferably steam, a recirculation method, a method for dispensing hot water, and a coffee machine.

In particular, the present invention belongs to the field of distributing hot beverages at a professional level, e.g., for bars, restaurants, and automatic vending machines or, at a domestic level, e.g., for domestic use.

Hot water distribution systems are known in the art and are generally integrated into the same dispensing group, often coupled to a steam distribution system. Generally, the known dispensing groups consist of a single fluidic conduit, which supplies two dispensing nozzles, for alternately dispensing hot water and steam.

Typically, in fact, known dispensing groups allow dispensing hot water or dispensing steam at different times because, as they generally have a single fluidic conduit supplying both dispensing operations, the water flow rates in the circuit are not sufficient to supply both dispensing operations, and it is simultaneously complicated and costly to heat and pump water in the same fluidic conduit at two different temperatures.

According to a further disadvantage, the known dispensing systems use heaters for heating containers for receiving the beverages, i.e., for keeping the mugs, cups, and glasses warm, so as to ensure keeping the beverages hot after being served to the end user, besides improving the feeling of comfort felt by grasping such containers.

Such heaters clearly require a special, thus costly supply and require ad hoc maintenance.

Moreover, boilers or storage boilers are often used in the known dispensing systems, in which great amounts of heated water are stored, in the same volume, which remains in the respective storage tank for a long time before being dispensed.

It is known that such systems can develop bacteriological loads, and even if the problem is under control and the known boilers and hot water heaters respect the health and safety standards, such systems require a specific control of the microbiological risk.

Moreover, such a drawback forces users to perform continuous and frequent cleaning cycles, resulting in waste in terms of time and resources.

### SOLUTION OF THE INVENTION

Thus, the need is strongly felt to provide a dispensing group capable of overcoming the drawbacks typical of the prior art.

In particular, it is the object of the present invention to improve the efficiency of the dispensing group, optimize the powers at stake for heating the water for the dispensing operations and, simultaneously, utilize the heat of combustion of the water to the full potential.

It is a further object of the present invention to allow the simultaneous dispensing of hot water and steam.

Such needs are met by a fluidic water conduit, a dispensing group, a coffee machine, a recirculation method, and a method for dispensing hot water according to the appended claims. The claims dependent thereon describe preferred or advantageous embodiments of the invention, involving further advantageous aspects.

### DESCRIPTION OF THE DRAWINGS

The features and advantages of the water fluidic conduit, the dispensing group, the coffee machine, the recirculation method, and the dispensing method will however become apparent from the following description of some preferred embodiments thereof, given by way of non-limiting indications, with reference to the accompanying drawings, in which:

FIG. 1 shows a fluidic circuit diagram of a dispensing group according to an embodiment of the present invention;

FIG. 2 shows a fluidic circuit diagram of a fluidic water conduit according to an embodiment of the present invention;

FIG. 3 shows a fluidic circuit diagram of a fluidic steam conduit of a dispensing group according to an embodiment of the present invention;

FIG. 4 shows a perspective view of a dispensing group according to an embodiment of the present invention;

FIG. 5a shows a lateral perspective view of a fluidic water conduit according to an embodiment of the present invention;

FIG. 5b shows a further lateral perspective view of the fluidic water conduit in FIG. 5a;

FIG. 5c shows a view from above of the fluidic water conduit in FIG. 5a;

FIG. 6 shows a lateral perspective view of a fluidic steam conduit according to an embodiment of the present invention;

FIG. 7 shows a perspective view of a dispensing group of the present invention, in an embodiment of the present invention;

FIG. 8 shows a perspective view of the dispensing group in FIG. 7, depicting the collection conduit arranged at a cup holder unit, according to an embodiment of the present invention;

FIG. 9 shows a perspective view of a coffee machine according to an embodiment of the present invention;

FIG. 10 shows a fluidic circuit diagram of a dispensing group according to a further embodiment of the present invention;

FIG. 11 shows a fluidic circuit diagram of a dispensing group according to a further embodiment of the present invention;

FIG. 12 shows a fluidic circuit diagram a dispensing group according to a further embodiment of the present invention.

### DETAILED DESCRIPTION

With reference to the aforesaid figures, reference numeral 11 globally denotes a fluidic conduit, referred to as the fluidic water conduit 11 for simplicity and intelligibility, for dispensing hot water.

According to the present invention, the fluidic water conduit 11 comprises:
a main branch 110 extending between a first water inlet opening 21 and a hot water dispensing opening 31 and which is suitable for receiving water through said first water inlet opening 21 and allowing said water to flow towards said hot water dispensing opening 31;
a first heating device 41, operatively connected to said main branch 110 and suitable for heating the water flowing into said main branch 110 before it reaches said hot water dispensing opening 31;
a recirculation branch 115, which fluidically originates from said main branch 110 downstream of the first heating device 41 and upstream of the hot water dispensing opening 31 and which is fluidically reintroduced into said main branch 110 upstream of said first heating device 41.

In other words, according to an advantageous aspect, the present invention provides that the fluidic water conduit 11 is equipped with a recirculation, i.e., it is suitable for recirculating preheated water by means of the first heating device 41, through said recirculation branch 115, and reintroducing such a preheated water into the main branch 110.

Advantageously, by virtue of the presence of the recirculation branch, which always provides a certain flow of preheated water for the dispensing, the fluidic conduit according to the present invention is capable of significantly reducing the time for dispensing hot water at a high temperature.

For example, by means of the first heating device 41 it is possible to preheat water to about 60 °C and send it into recirculation in the recirculation branch 115, subsequently reaching the main branch 110 again.

Thereby, when the dispensing of hot water, typically boiling water, is requested, preferably about 90-95 °C, for preparing hot beverages, such as teas or herbal drinks, it is possible to apply a reduced final heating to the previously preheated water, by means of the first heating device 41.

Advantageously, such a feature of the fluidic water conduit also allows utilizing heating devices with reduced powers, as compared to the typical heaters of the prior art, at the same required dispensing temperature.

According to the invention, the main branch 110 comprises a collection conduit 500, suitable for accumulating water preheated by the first heating device 41 and reintroduced into the main branch 110 by means of the recirculation branch 115, said collection conduit 500 being at least partially thermally conductive for allowing the transmission of heat of the heated hot water accumulated in the collection conduit 500, towards the environment.

In other words, the collection conduit 500 is at least partially not insulated, i.e., it comprises at least one exchange wall 550 suitable for allowing the heat exchange between the heated water inside the collection conduit 500 and the environment, through said exchange wall 550.

More generally, the expression “towards the environment” is understood to mean “towards the outside of the collection conduit”, i.e., towards any chamber, or element, arranged outside said conduit.

Preferably, the whole outer wall of the collection conduit is suitable for allowing the heat exchange, i.e., the whole collection conduit is not insulated.

Advantageously, by virtue of such a feature, the heated water stored in the collection conduit 500 can be exploited for a dual purpose: on the one hand, a certain flow of preheated water is provided to allow hot water to be dispensed more quickly at a high temperature, on the other hand, the use of the heat of combustion of the heated water in the collection conduit 500 is allowed to transmit heat passively to elements close to such a collection conduit, which need to be heated, like other fluidic conduits or further dispensing group elements, such as a cup holder unit, for example, as is better explained later in the present discussion.

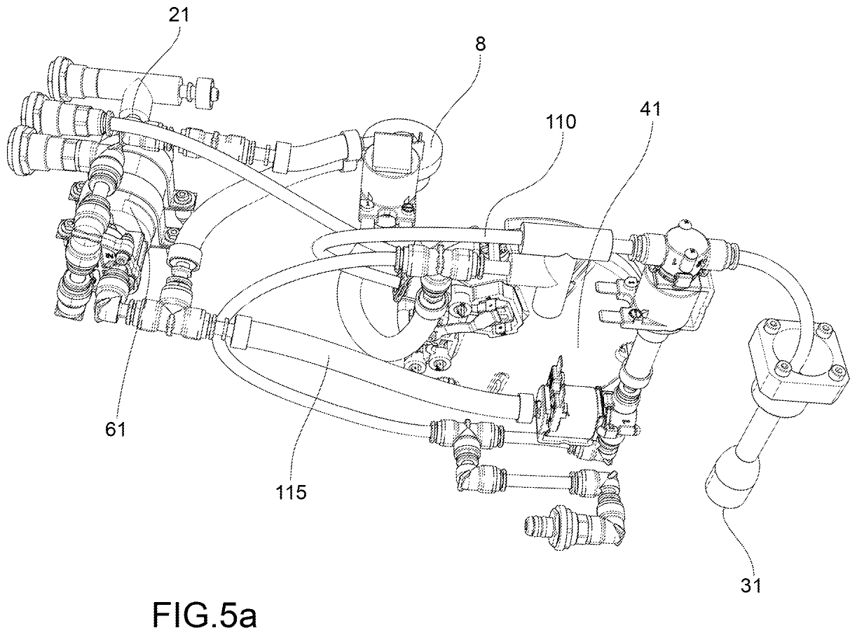

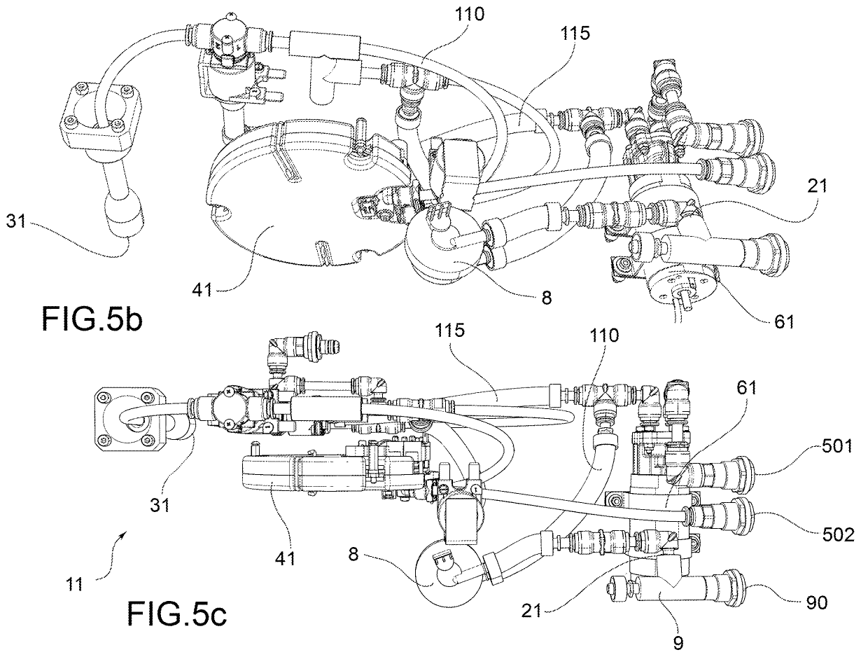

Preferably, as shown for example in FIGS. 5a, 5b and 5c, the hot water dispensing opening 31 is connected to, or obtained in, a hot water outlet nozzle, designed to direct a flow of hot water to a collection container, e.g., a cup or a glass.

In an embodiment of the invention, the first heating device 41 is installed close to the hot water dispensing opening 31.

Preferably, the first heating device 41 is an instantaneous heater, even more preferably, it is a heater of the FTH (Flow Through Heater) type.

In a preferred embodiment, the fluidic water conduit 11 comprises a first pump 61, preferably a rotary pump, installed upstream of the first heating device 41 and suitable for pushing water into the main branch 110 towards said first heating device 41.

In a preferred embodiment, the recirculation branch 115 is reintroduced into the main branch 110 upstream of said first pump 61.

In this document, the expressions “upstream” and “downstream” are always used with reference to the water flow direction from the first and second water inlet openings 21, 22 towards the hot water dispensing opening 31 or towards the steam dispensing opening 32, respectively.

Moreover, in a preferred embodiment, the collection conduit 500 is interposed between the first pump 61 and the first heating device 41.

Advantageously, by virtue of the presence of the first pump 61 it is possible to regulate the hot water dispensing time by acting both on the power of the first heating device 41 and on the power of the first pump 61.

Preferably, the collection conduit 500 is a tube extending over a collection length L along a prevalent flow direction X and having a cross-section on a plane transverse to said prevalent flow direction X defined by a transverse dimension D, where said collection length is much greater than said transverse dimension D.

It is apparent that prevalent flow direction X does not only mean a linear direction, but it also refers to a sinuous direction, e. g., a curved or broken or mixed trajectory, comprising linear and/or curved and/or broken stretches, which follows the direction of the water flow in the conduit.

For example, the collection conduit 500 is a tube having a collection length L along the prevalent flow direction X and having a circular cross-section defined by a diameter D, where the length L is much greater than the diameter D. In other words, the collection conduit is a long and narrow tube.

In a preferred embodiment, the collection length L is at least ten times the transverse dimension D, preferably at least fifty times the transverse dimension D, even more preferably, at least one hundred times the transverse dimension D.

Preferably, the collection conduit 500 has a meandering development, i.e., it forms a fluidic serpentine, comprising linear stretches 510 interspersed with curvilinear stretches 520.

In an embodiment, the collection conduit 500 extends from a first end 501 to a second end 502.

Preferably, at said first and second ends 501, 502, the fluidic water conduit 11 comprises non-return valves 74 suitable for being opened and closed for allowing or blocking the passage of preheated water, respectively, from the recirculation branch towards the collection conduit 500 and from the collection conduit 500 towards the first heating device 41.

Moreover, in an embodiment, the main branch 110 comprises an emission node 300 downstream of the first heating device 41 and upstream of the hot water dispensing opening 31, where the recirculation branch 115 fluidically originates from the main branch 110 at said emission node 300.

Preferably, the fluidic water conduit 11 comprises a flow regulating element 71 at said emission node 300, suitable for regulating the water flow from the main branch 110 towards the hot water dispensing opening 31 or towards the recirculation branch 115.

In an advantageous embodiment, such a flow regulating element 71 is a three-way valve.

Preferably, the fluidic water conduit 11 comprises an electronic control unit 75 operatively connected to said flow regulating element 71 and configured to process and send to said flow regulating element 71:
a dispensing signal for allowing water to pass from the main branch 110 towards the hot water dispensing opening 31; or
a recirculation signal for allowing water to pass from the main branch 110 towards the recirculation branch 115.

Moreover, in a preferred embodiment, the fluidic water conduit 1 according to the preceding claim comprises a hot water temperature sensor 700, installed on the fluidic water conduit 11 and configured to detect the temperature of the water in the main branch 110, downstream of the first heating device 41.

The present invention also relates to a dispensing group 1 for dispensing hot water, comprising a fluidic water conduit 11 according to an embodiment of the present invention and a cup holder unit 600 arranged close to the collection conduit 500 so that the heating of at least one surface of said cup holder unit 600 is allowed by means of the transmission of heat from the water contained in said collection conduit 500 towards said cup holder unit 600.

In a preferred embodiment, the cup holder unit 600 comprises and delimits therein a heating chamber 650 suitable for accommodating the collection conduit 500 and closed at the top by means of a cup holder plate 680, as to conceal the collection conduit 500 from the user's sight, where said cup holder plate 680 is suitable for holding mugs, cups, glasses, to be heated.

Preferably, the dispensing group 1 is also suitable for dispensing steam and further comprises:
a fluidic steam conduit 12 extending between a second water inlet opening 22 and a steam dispensing opening 32, said fluidic steam conduit 12 being suitable for receiving water through said second water inlet opening 22 and allowing said water to flow towards said steam dispensing opening 32;
a second heating device 42, operatively connected to said fluidic steam conduit 12 and suitable for heating the water flowing into said fluidic steam conduit 12 to generate steam, before it reaches said steam dispensing opening 32.

Thereby, the dispensing group 1 is also suitable for dispensing steam, through the steam dispensing opening 32, which is different to the hot water dispensing opening 31.

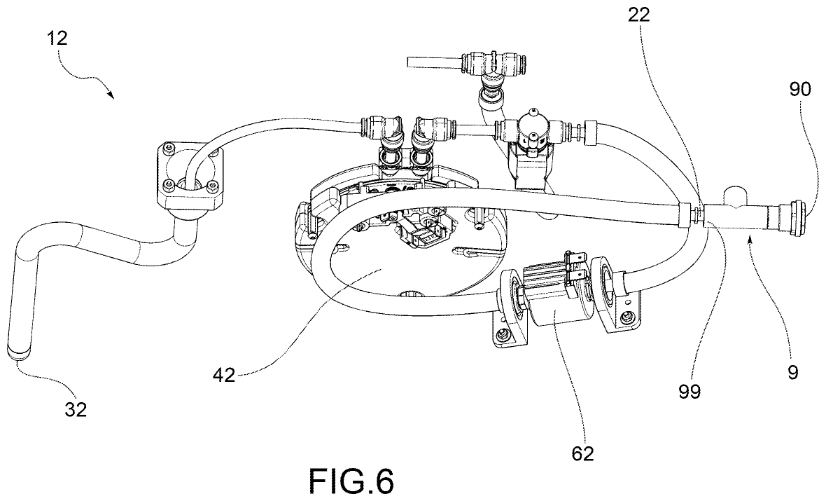

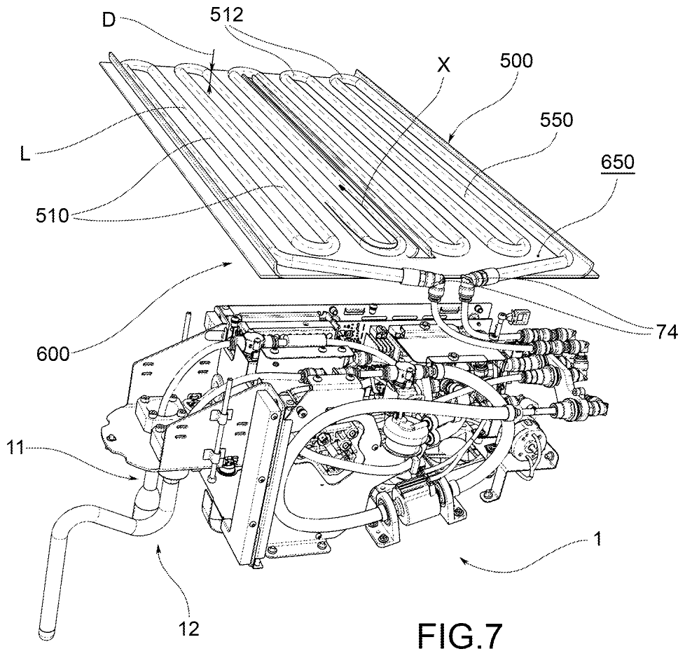

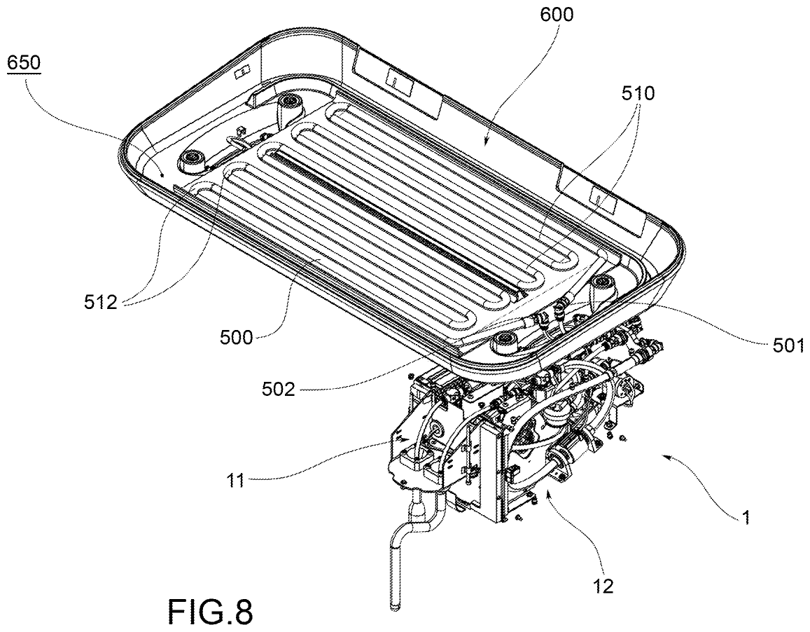

Preferably, as shown for example in FIG. 6, the steam dispensing opening 32 is connected to, or obtained in, a steam outlet nozzle, designed to direct a flow of steam into a fluid contained in a collection container, e.g., a cup or a glass, or a pan containing milk.

In an embodiment of the invention, the second heating device 42 is installed close to the steam dispensing opening 32.

Preferably, the second heating device 42 is an instantaneous heater, even more preferably, it is a heater of the FTH (Flow Through Heater) type.

In a particularly advantageous embodiment, the fluidic water conduit 11 and the fluidic steam conduit 12 are fluidically and thermally separate from each other in the path thereof between the first water inlet opening 21 and the hot water dispensing opening 31, and between the second water inlet opening 22 and the steam dispensing opening 32, respectively.

In other words, according to the present embodiment, the dispensing group 1 comprises two fluidic conduits, which are kept fluidically and thermally separate from each other, the fluidic water conduit 11 for producing and dispensing hot water, and the fluidic steam conduit 12 for producing and dispensing steam.

The definition “fluidically separate” is understood to mean that such fluidic water and steam conduits 11, 12 do not have fluidic nodes in common along the respective path thereof. That is, for example, the water entering the fluidic water conduit 11 cannot reach the fluidic steam conduit 12, and vice versa.

The definition “thermally separate” is understood to mean that such fluidic water and steam conduits 11, 12 do not directly influence each other, i.e., they do not contribute directly to heating or, more generally, to varying the temperature of the other, or of the water flowing therein. In other words, for example, the first heating device 41 only thermally influences the water flowing in the fluidic water conduit 11. Likewise, the second heating device 42 only thermally influences the water flowing into the fluidic steam conduit 12.

In an embodiment, described in detail in this document below, the fluidic conduits are kept fluidically and thermally separate, but the fluidic steam conduit 12 is heated indirectly, in a preheating stretch 120—in a passive manner—by means of the transmission of heat from the collection conduit 500 towards said preheating stretch 120.

Moreover, according to an advantageous embodiment, the first heating device 41 and the second heating device 42 are completely disconnected from each other both fluidically and thermally.

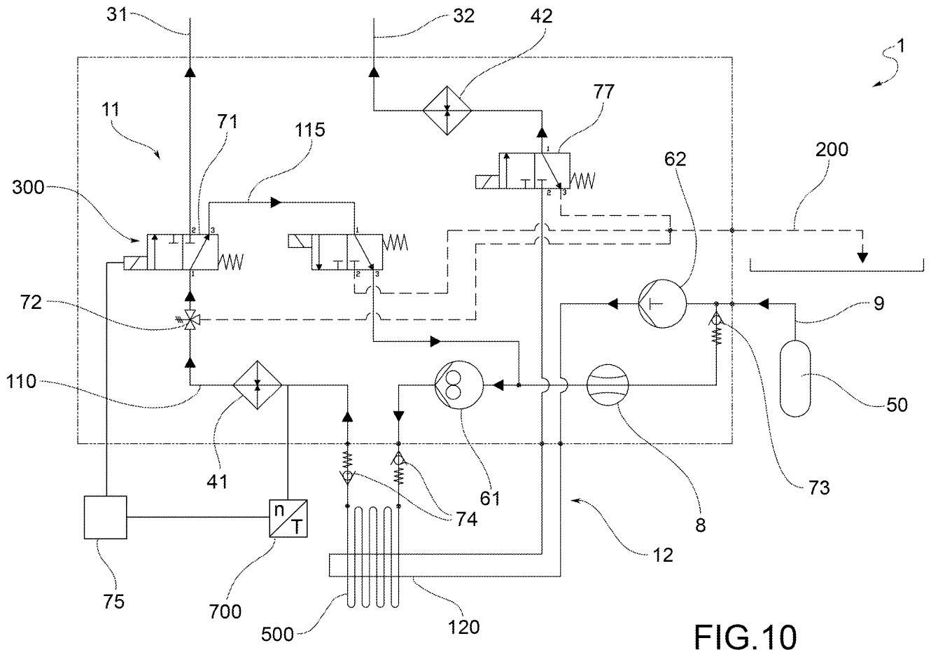

In an embodiment, for example shown in FIG. 10, the fluidic steam conduit 12 comprises a preheating stretch 120 passing close to the collection conduit 500, so that the collection conduit 500 allows heat to be transferred from the preheated water therein, to the preheating stretch 120, so as to also ensure a minimum preheating of the water flowing into the fluidic steam conduit 12.

In such an embodiment, the collection conduit 500 is suitable for allowing heat to be transferred from the preheated water therein to the preheating stretch 120, so as to also allow preheating the water flowing into the fluidic steam conduit 12. That is, the fluidic water conduit 11 and the fluidic steam conduit 12 are kept thermally and fluidically separate and the fluidic steam conduit 12 undergoes a passive preheating by proximity to said collection conduit 500.

Thereby, the dispensing of steam is also facilitated and, at the same final dispensing temperature, it allows using a heater with reduced power as compared to the heaters used in the prior art for generating steam.

In an embodiment, the dispensing group 1 further comprises an overpressure relief valve 72 installed on the fluidic water conduit 11, preferably downstream of the first pump 61, even more preferably downstream of the collection conduit 500.

In an embodiment, the dispensing group comprises a discharge branch 200, fluidically connectable to the fluidic water conduit 11 and/or to the fluidic steam conduit 12 for allowing water and/or steam to be released, if necessary.

Preferably, the overpressure relief valve 72 is suitable for regulating the flow of hot water from the main branch 110 towards the hot water dispensing opening 31, or towards the recirculation branch 115 or towards the discharge branch 200, where necessary.

In an embodiment, the dispensing group 1 comprises a steam regulating element 77 installed on the fluidic steam conduit 12, preferably downstream of the second pump 62.

Preferably, such a steam regulating element 77 is suitable for regulating the water flow towards the steam dispensing opening 32, flowing from the second heating device 42, or towards the discharge branch 200.

In an embodiment, the fluidic steam conduit 12 originates from the fluidic water conduit 11 at the collection conduit 500.

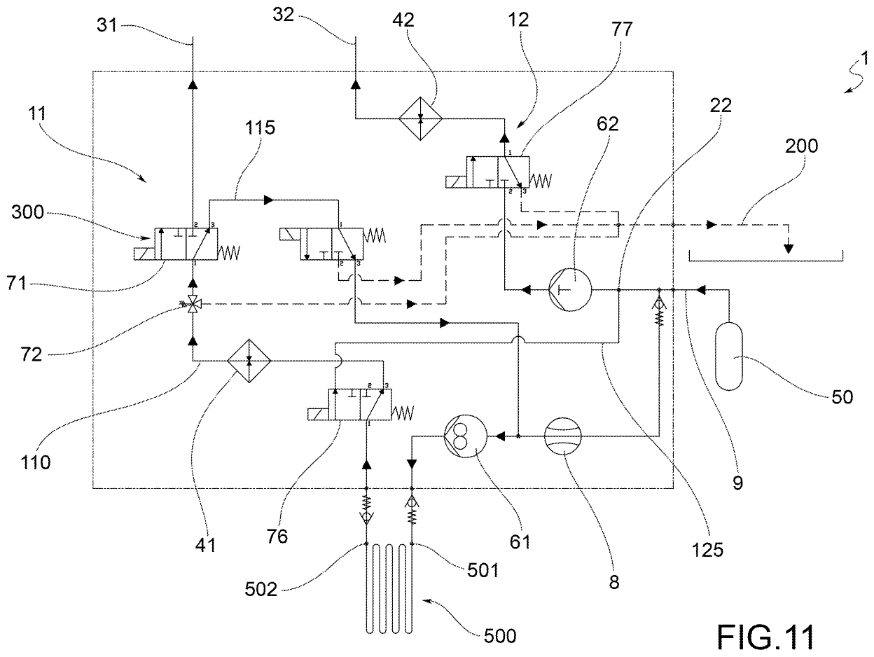

In an embodiment, for example shown in FIG. 11, the fluidic steam conduit 12 comprises a tapping branch 125 with which it is connected to the fluidic water conduit 11 downstream of the collection conduit 500.

In other words, the fluidic steam conduit 12 is connected to the collection conduit 500 or downstream of the latter and is suitable for receiving water from the collection conduit 500 through the second water inlet opening 22, so that the fluidic steam conduit 12 receives water that has been preheated by means of the first heating device 41 in the fluidic water conduit 11 and performs a final heating by means of the second heating device 42, to transform the preheated water into steam.

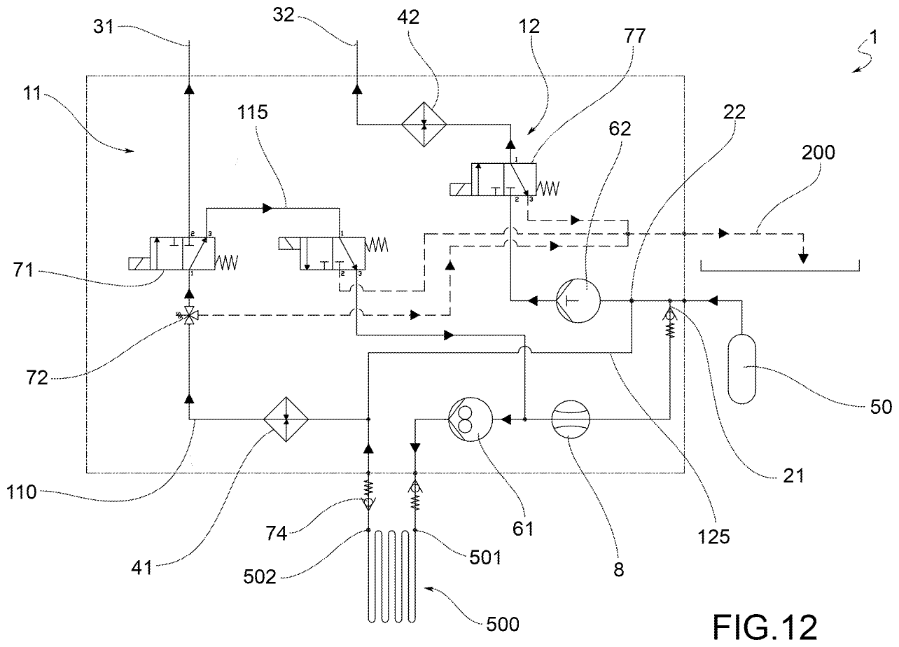

Preferably, the dispensing group 1 comprises an auxiliary regulating element 76 suitable for regulating the preheated flow of water accumulated in the collection conduit 500 towards the hot water dispensing opening 31 or towards the fluidic steam conduit 12. Therefore, such an auxiliary regulating element 76 is preferably installed at the connection between the tapping branch 125 and the fluidic conduit 11, as shown in the embodiment in FIG. 12.

According to an embodiment, the electronic control unit 75 is connected to a user interface by means of which a user can send, to the dispensing group (or to the fluidic water conduit) , a hot water dispensing command, and/or he/she can manually command the flow regulating element 71 to regulate the passage of water towards the hot water dispensing opening or towards the recirculation branch.

In an embodiment, the dispensing group 1 comprises a tank 50, preferably containing water at room temperature or cold water, fluidically connected to the fluidic water conduit 11 by means of the first water inlet opening 21, and to the fluidic steam conduit 12 by means of the second water inlet opening 22.

In other words, in such an embodiment, each fluidic water and steam conduit 11, 12 is directly connected to the tank 50 by means of the respective water inlet opening 21, 22.

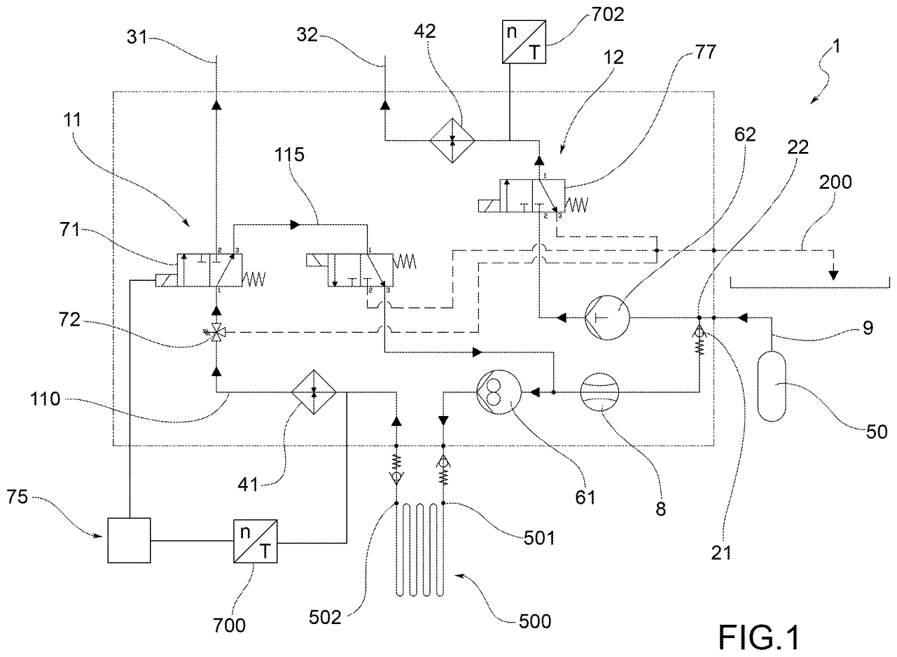

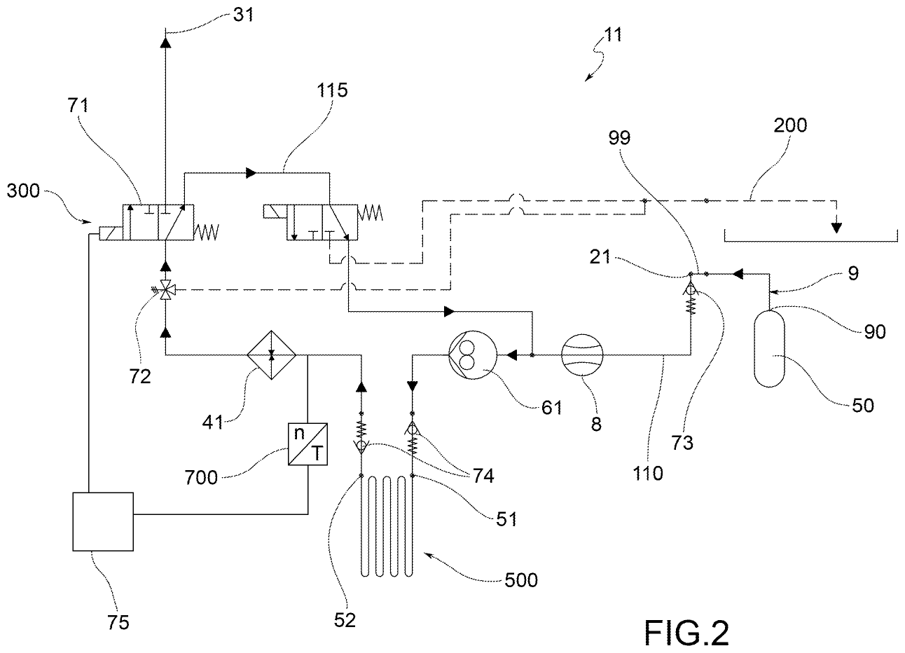

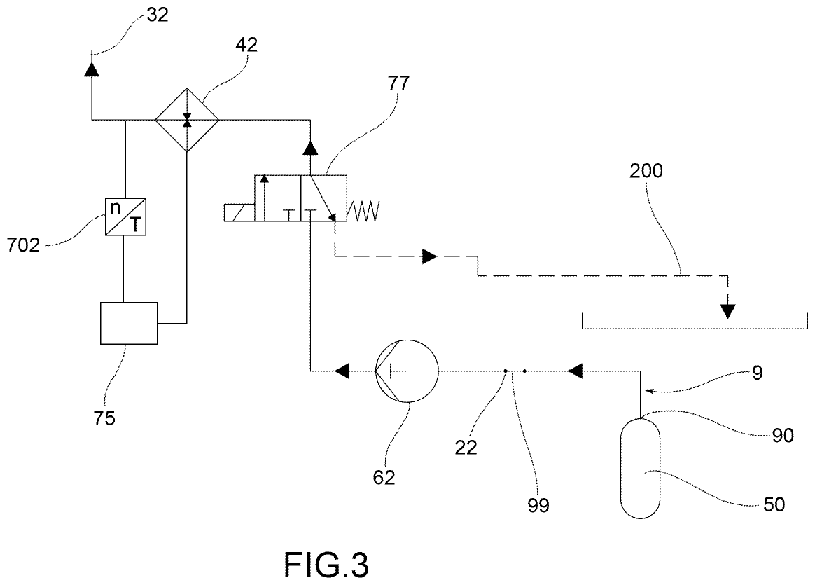

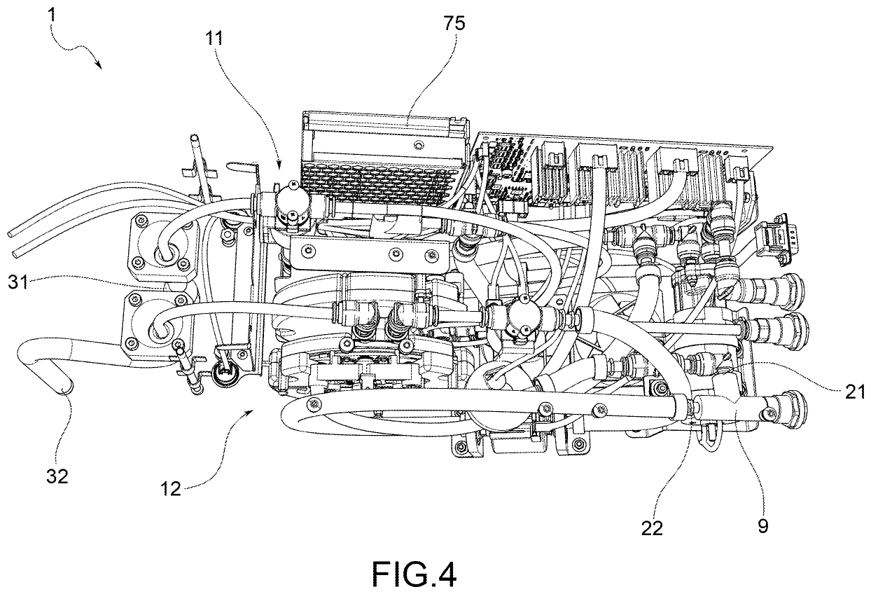

In an embodiment, for example shown in FIGS. 1, 2 and 3, the dispensing group 1 comprises a junction conduit 9 having a first end 90, fluidically connected to the tank 50, which is suitable for containing water, and a second end 99, fluidically connected to the fluidic water conduit 11 and to the fluidic steam conduit 12 by means of the first 21 and second 22 water inlet openings, respectively.

Such a junction conduit 9 is suitable for indirectly connecting the fluidic water conduit 11 and the fluidic steam conduit 12 to the tank 50.

Preferably, the first opening 21 and the second water inlet opening 22 are both connected to the same second end 99 of the junction conduit 9.

Preferably, a regulating valve is installed at such a second end 99, which is suitable for regulating the water flow from the tank 50 towards the fluidic water conduit 11 through said first water inlet opening 21, and/or towards the fluidic steam conduit 12 through said second water inlet opening 22.

In an advantageous embodiment, the regulating valve is suitable for allowing the simultaneous flow in both the fluidic water conduit 11 and the fluidic steam conduit 12.

Thereby, advantageously, also by virtue of the separation between the two fluidic conduits 11 and 12 and by virtue of the presence of the thermally Separate first heating device 41 and second heating device 42, the simultaneous dispensing of hot water is allowed through the hot water dispensing opening 31 and steam through the steam dispensing opening 32.

Moreover, a non-return valve 73 is preferably installed at the first water inlet opening 21, suitable for blocking the return of the water entering the fluidic water conduit 11, towards the tank 50 or towards the fluidic steam conduit 12.

In an embodiment, the fluidic steam conduit 12 comprises a second pump 62, preferably a volumetric pump, installed upstream of the second heating device 42 and suitable for pushing water into the fluidic steam conduit 12 towards said second heating device 42.

In an embodiment, the dispensing group 1 comprises one or more steam temperature sensors 702, installed on the fluidic steam conduit 12 and configured to detect the temperature of the water in the fluidic steam conduit 12, upstream of the second heating device 42, close thereto.

Preferably, the electronic control unit 75 is connected to said one or more steam temperature sensors 702 and is configured to regulate the flow rate passing from the second heating device 42 as a function of the temperature detected by said one or more steam temperature sensors 702.

Preferably, the flow rate passing from the second heating device 42 is regulated by acting on the power of the second pump 62.

In a constructional variant, the dispensing group 1 further comprises a flow rate measurer 8, e. g., a flow meter installed on the fluidic water conduit 11.

Preferably, such a flow rate measurer 8 is installed on the main branch 110, even more preferably, upstream of the first pump 61.

In an embodiment, the recirculation branch 115 is reintroduced into the main branch 110 downstream of said flow rate measurer 8 and upstream of the first pump 61.

In a constructional variant, the dispensing group comprises a flow rate measurer 8 installed on the junction conduit 9.

In an advantageous embodiment, the fluidic water conduit 11 and the fluidic steam conduit 12 are separate at least from a node downstream of the flow rate measurer 8.

The present invention also relates to a preheated water recirculation conduit, comprising the following steps:
a) providing fluidic water conduit 11 according to the present invention;
b) allowing water to pass into the main branch 110 from the first water inlet opening 21 towards the hot water dispensing opening 31;
c) by means of the first heating device 41, pre-heating the water flowing into said main branch 110 to generate an amount of preheated water at a predetermined preheating temperature;
d) blocking the passage of said amount of preheated water towards the hot water dispensing opening 31 and allowing said amount of preheated water to pass from the main branch 110, downstream of the first heating device 41, into the recirculation branch 115;
e) re-introducing said amount of preheated water from the recirculation branch 115 into the main branch 110 upstream of said first heating device 41.

The present invention also relates to a method for dispensing hot water, comprising the following steps:
f) performing a method for recirculating preheated water according to the present invention;
g) providing an electronic control unit 75 operatively connected to the fluidic water conduit 11;
h) by means of the electronic control unit 75, preferably in response to a hot water dispensing command sent by a user, preferably by means of a user interface, sending a hot water dispensing signal to the fluidic water conduit 11;
i) as a function of said hot water dispensing signal, by means of the first heating device 41 performing a final heating of a volume of water to be dispensed comprising the amount of preheated water reintroduced into the main branch 110 and/or an amount of unheated water entering the main branch 110 from the first water inlet opening 21 to bring it to a predetermined dispensing temperature;
j) allowing heated water at the predetermined dispensing temperature to pass through the hot water dispensing opening 31.

It is apparent that, depending on the volume of water required for the dispensing, the amount of preheated water accumulated in the collection conduit 500 and available for the subsequent final heating may or may not be sufficient to ensure the dispensing of such a volume. It is apparent that, at the same time as the dispensing, the method includes that the main branch 110 continues to receive water entering through the first water inlet opening 21.

Thereby, on the one hand, the constant filling of the main branch 110 is advantageously ensured, avoiding the formation of air bubbles, which would be detrimental to the operation of the heating device. Advantageously, at the same time, such a system theoretically allows the dispensing group to dispense any volume of hot water without interruptions.

Therefore, in an embodiment, the first heating device 41 must be suitable for performing the final heating of a certain amount of water, which is at a preheating temperature, e.g., 60 °C, and of a certain amount of water, which is at a reduced temperature instead, e. g., at room temperature, and bringing both such amounts of water to a predetermined dispensing temperature, e. g., 90 °C.

In a preferred embodiment, step i) comprises the following sub-steps:
i1) providing a temperature sensor 700 suitable for detecting the temperature of the water at the first heating device 41, which is operatively connected to the electronic control unit 75;
i2) by means of the electronic control unit 75, making a comparison between the temperature detected by said temperature sensor and a minimum preheating temperature;
i3) as a function of said comparison, performing one of the following actions:
i31) if the detected temperature is greater than or equal to said minimum preheating temperature, heating the water by means of the first heating device 41 at a maximum water flow rate, to bring it to the dispensing temperature;
i32) if the detected temperature is lower than the minimum preheating temperature, heating the water by means of the first heating device 41 at a lower water flow rate than the maximum water flow rate, to bring it to the dispensing temperature.

In other words, with the same power, the first heating device 41 is suitable for heating a reduced flow of water—and consequently producing a slower exiting flow of hot water—when the temperature of the water to be heated is below the minimum preheating temperature, and, on the contrary, it is suitable for heating a greater flow of water (e.g., the maximum one)—and consequently, producing a faster exiting flow of hot water—when the temperature of the water to be heated is at least at the minimum preheating temperature.

Clearly, this is due to the fact that, with the same power and working with previously preheated water, the first heating device 41 must perform thereon a reduced heating and therefore, advantageously, it is able to process a greater flow at the dispensing temperature in a shorter time.

Preferably, after step j), the method includes performing again the recirculation method according to the present invention, so as to immediately provide an amount of preheated water for a subsequent dispensing.

Preferably, moreover, the recirculation is also started after not using the dispensing group for a certain time, so as to prevent the deposit and growth of bacterial agents or pathogens in the conduit.

It is apparent that the recirculation is preferably started during the non-working steps of the dispensing group or fluidic water conduit, i.e., when the dispensing of hot water and steam is not required.

It is equally apparent that the method of dispensing hot water can take place at the same time as a method of dispensing steam, consisting of the following steps:
a) providing a hot water and steam dispensing group 1 according to the present invention, where the fluidic water conduit 11 and the fluidic steam conduit 12 are thermally and fluidically separate;
m) dispensing water into the fluidic steam conduit 12 through the second water inlet opening 22;
n) by means of the second heating device 42, heating the water in the fluidic steam conduit 12 at a steam dispensing temperature, so as to generate steam;

o) dispensing steam by means of the steam dispensing opening 32.

It is apparent that the dispensing group according to the present invention is suitable for operating as an independent unit or for being integrated into household appliances with other functionalities, e.g., integrated into a domestic or professional coffee machine.

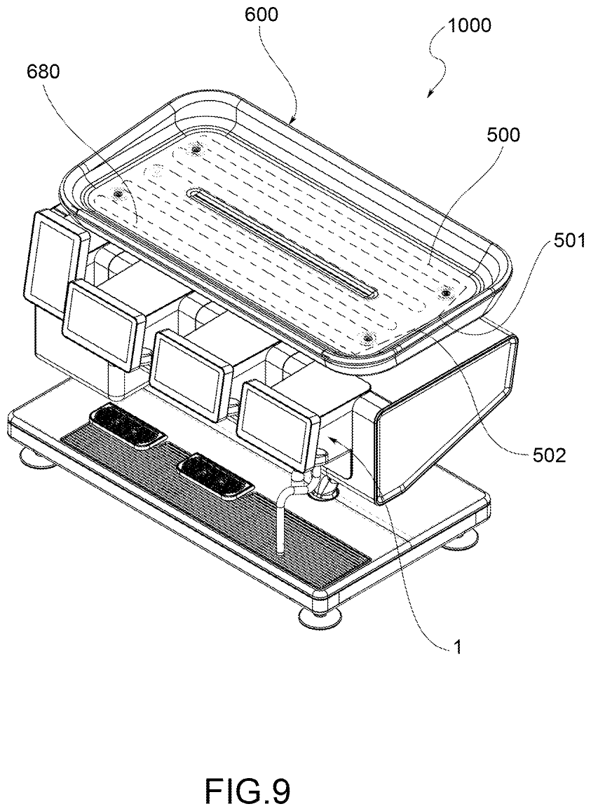

Therefore, the present invention also relates to a coffee machine 1000, for example shown in an embodiment in FIG. 9, comprising a coffee dispensing unit and a dispensing group 1 according to the present invention.

Innovatively, the present invention overcomes the drawbacks of the typical dispensing groups of the prior art.

In fact, advantageously, by virtue of the technical features described in this document, the fluidic water conduit according to the present invention allows significantly improving the efficiency of the water and steam dispensing system.

According to a surprising advantage, by virtue of the presence of a recirculation branch in the fluidic water conduit, the hot water dispensing time is reduced. In other words, the possibility of always providing a certain amount of preheated water, allows applying only a minimum final heating, to bring such water to the dispensing temperature and consequently, with the same power as the heating device, the present dispensing group allows dispensing a greater water flow at the dispensing temperature in a shorter time.

Thereby, the delay—i.e., the waiting time—between the dispensing command and the dispensing is reduced.

Moreover, in relation to such an advantage, note the convenience of being able to use a heater with reduced power with respect to the heaters used in the prior art, for providing hot water at the same dispensing temperature.

Moreover, the collection conduit in the fluidic water conduit advantageously allows utilizing the heat of combustion of the preheated water accumulated in such a conduit for heating further parts of the dispensing group or the coffee machine, e.g., for heating a cup holder plate, so as to have preheated mugs and cups ready to receive the hot beverages.

Hence, this advantageously allows abandoning auxiliary heating systems for heating the cup holder unit and therefore a great saving in resources.

Moreover, the fluidic and electrical design of the whole dispensing group is conveniently simplified.

According to a further advantage, by virtue of the presence of two fluidic water and steam conduits, which are completely fluidically and thermally separate, the dispensing group allows simultaneously dispensing hot water and steam at the standard dispensing flow rates.

According to an even further advantage, the provision of two fluidically and thermally separate fluidic conduits allows operating on the parameters for dispensing hot water and steam (such as, the flow rate, temperature, pressure, dispensing speed, for example) completely independently.

Clearly, this allows regulating each dispensing according to the user's specific needs without influencing the parameters of the dispensing, taking place in parallel.

It is apparent that, in order to meet specific needs, those skilled in the art may make variations to the embodiments of the aforesaid dispensing group and the aforesaid coffee machine, or replace elements with others which are functionally equivalent.

Such variations are also contained within the scope of protection as defined by the following claims. Moreover, each variation described as belonging to a possible embodiment can be implemented irrespective of the other variations described.

### LIST OF REFERENCE SIGNS

1 dispensing group
11 fluidic water conduit
12 fluidic steam conduit
110 main branch
115 recirculation branch
120 preheating stretch
125 tapping branch
21 first water inlet opening
22 second water inlet opening
200 discharge branch
31 hot water dispensing opening
32 steam dispensing opening
300 emission node
41 first heating device
42 second heating device
50 tank
500 collection conduit
501 first end
502 second end
510 linear stretches
520 curvilinear stretches
550 exchange wall
61 first pump
62 second pump
600 cup holder unit
650 heating chamber
680 cup holder plate
71 flow regulating element
72 overpressure relief valve
74 non-return valves
75 electronic control unit
76 auxiliary regulating element
77 steam regulating element
700 temperature sensor
702 steam temperature sensors
8 flow rate measurer
9 junction conduit
90 first end
99 second end
L storage length
X prevalent flow direction
D transverse dimension

What is claimed is:

1. A fluidic water conduit for dispensing hot water, comprising:
a main branch extending between a first water inlet opening and a hot water dispensing opening and suitable for receiving water through said first water inlet opening and allowing said water to flow towards said hot water dispensing opening;
a first heating device operatively connected to said main branch and suitable for heating the water flowing into said main branch before the water reaches said hot water dispensing opening;
a recirculation branch, which fluidically originates from said main branch downstream of the first heating device and upstream of the hot water dispensing opening and which is fluidically reintroduced into said main branch upstream of said first heating device,
wherein the main branch comprises a collection conduit, suitable for accumulating water preheated by the first heating device and reintroduced into the main branch by the recirculation branch, said collection conduit being at least partially thermally conductive for allowing transmission of heat of the preheated water accumulated in the collection conduit, towards an environment.

2. The fluidic water conduit of claim 1, further comprising a first pump, optionally the first pump being a rotary pump, installed upstream of the first heating device and suitable for pushing the water into the main branch towards said first heating device.

3. The fluidic water conduit of claim 2, wherein the recirculation branch is reintroduced into the main branch upstream of said first pump, and wherein the collection conduit is interposed between the first pump and the first heating device.

4. Fluidic The fluidic water conduit to of claim 3, wherein the collection conduit extends from a first end to a second end and wherein, at said first and second ends, the fluidic water conduit comprises non-return valves suitable for being opened and closed, respectively, for allowing or blocking a passage of the preheated water from the recirculation branch to the collection conduit and from the collection conduit towards the first heating device.

5. The fluidic water conduit of claim 1, wherein the collection conduit is a tube extending for a collection length along a prevalent flow direction and having a cross-section on a plane transversal to said prevalent flow direction defined by a transversal dimension, and wherein said collection length is much greater than said transversal dimension.

6. The fluidic water conduit of claim 5, wherein the collection length is at least ten times the transversal dimension, preferably at least fifty times the transversal dimension, even more preferably, at least one hundred times the transversal dimension.

7. The fluidic water conduit of claim 1, wherein the collection conduit has a snakelike development, the collection conduit forming a fluidic serpentine, comprising linear stretches interspersed with curvilinear stretches.

8. The fluidic water conduit of claim 1, wherein the main branch comprises an emission node downstream of the first heating device and upstream of the hot water dispensing opening, wherein the recirculation branch fluidically originates from the main branch at said emission node, and wherein the fluidic conduit comprises a flow regulating element in correspondence of said emission node, suitable for regulating a water flow from the main branch towards the hot water dispensing opening or towards the recirculation branch.

9. The fluidic water conduit of claim 8, further comprising an electronic control unit operatively connected to said flow regulating element and configured to process and send to said flow regulating element:
a dispensing signal, for allowing a passage of water from the main branch towards the hot water dispensing opening; or
a recirculation signal, for allowing a passage of water from the main branch towards the recirculation branch.

10. A dispensing group for dispensing hot water, comprising the fluidic water conduit claim 1 and a cup holder unit positioned in proximity to the collection conduit (500) so that heating of at least one surface of said cup holder unit is allowed by the transmission of heat from the preheated water contained in said collection conduit towards said cup holder unit.

11. The dispensing group of claim 10, wherein the cup holder unit comprises and delimits therein a heating chamber suitable for accommodating the collection conduit and closed at a top by a cup holder plate, so as to conceal the collection conduit from a user's sight, and wherein said cup holder plate is suitable for holding cups, small cups, and glasses, to be heated.

12. The dispensing group of claim 10, further comprising:
a fluidic steam conduit extending between a second water inlet opening and a steam dispensing opening, said fluidic steam conduit being suitable for receiving the water through said second water inlet opening and allowing said water to flow towards said steam dispensing opening; and
a second heating device, operatively connected to said fluidic steam conduit and suitable for heating the water flowing into said fluidic steam conduit to generate steam, before the water reaches said steam dispensing opening,
so that the dispensing group is also suitable for dispensing steam, through the steam dispensing opening which is different from the hot water dispensing opening.

13. The dispensing group according to of claim 12, wherein the fluidic water conduit and the fluidic steam conduit are fluidically and thermally separate from each other in a path thereof respectively between the first water inlet opening and the hot water dispensing opening and between the second water inlet opening and the steam dispensing opening.

14. The dispensing group of claim 13, wherein the fluidic steam conduit comprises a preheating stretch passing in proximity to the collection conduit so that the collection conduit allows heat to be transferred from the preheated water accumulated therein, to the preheating stretch, so as to ensure a preheating minimum also of the water passing into the fluidic steam conduit.

15. The dispensing group of claim 12, wherein the fluidic steam conduit is connected to the fluidic water conduit at, or downstream of the collection conduit, wherein the fluidic steam conduit is connected to the collection conduit and is suitable for receiving the water from the collection conduit through the second water inlet opening, so that the fluidic steam conduit receives the water that has been preheated by the first heating device in the fluidic water conduit and performs a final heating by the second heating device to transform the preheated water into steam.

16. A method of recirculating preheated water, the method comprising
a) providing a fluidic water conduit for dispensing hot water, comprising:
a main branch extending between a first water inlet opening and a hot water dispensing opening and suitable for receiving water through said first water inlet opening and allowing said water to flow towards said hot water dispensing opening;
a first heating device operatively connected to said main branch and suitable for heating the water flowing into said main branch before the water reaches said hot water dispensing opening;
a recirculation branch, which fluidically originates from said main branch downstream of the first heating device and upstream of the hot water dispensing opening and which is fluidically reintroduced into said main branch upstream of said first heating device.
wherein the main branch comprises a collection conduit suitable for accumulating water preheated by the first heating device and reintroduced into the main branch by the recirculation branch, said collection conduit being at least partially thermally conductive for allowing transmission of heat of the preheated water accumulated in the collection conduit, towards an environment;
b) allowing the water to pass into the main branch from the first water inlet opening towards the hot water dispensing opening;
c) by the first heating device, preheating the water crossing said main branch to generate an amount of preheated water at a predetermined preheating temperature;
d) blocking a passage of said amount of preheated water towards the hot water dispensing opening and allowing said amount of preheated water to pass from the main branch , downstream of the first heating device, into the recirculation branch; and
e) re-introducing said amount of preheated water by the recirculation branch into the main branch upstream of said first heating device.

17. A method of dispensing hot water, the method comprising:
f) performing a method of recirculating preheated water comprising:
a) providing a fluidic water conduit for dispensing hot water, comprising:
a main branch extending between a first water inlet opening and a hot water dispensing opening and suitable for receiving water through said first water inlet opening and allowing said water to flow towards said hot water dispensing opening;
a first heating device operatively connected to said main branch and suitable for heating the water flowing into said main branch before the water reaches said hot water dispensing opening;
a recirculation branch, which fluidically originates from said main branch downstream of the first heating device and upstream of the hot water dispensing opening and which is fluidically reintroduced into said main branch upstream of said first heating device,
wherein the main branch comprises a collection conduit suitable for accumulating water preheated by the first heating device and reintroduced into the main branch by the recirculation branch, said collection conduit being at least partially thermally conductive for allowing transmission of heat of the preheated water accumulated in the collection conduit, towards an environment;
b) allowing the water to pass into the main branch from the first water inlet opening towards the hot water dispensing opening;
c) by the first heating device, preheating the water crossing said main branch to generate an amount of preheated water at a predetermined preheating temperature;
d) blocking a passage of said amount of preheated water towards the hot water dispensing opening and allowing said amount of preheated water to pass from the main branch, downstream of the first heating device, into the recirculation branch; and
e) re-introducing said amount of preheated water by the recirculation branch into the main branch upstream of said first heating device;
g) providing an electronic control unit operatively connected to the fluidic water conduit;
h) by the electronic control unit, preferably in response to a hot water dispensing command sent by a user, preferably by a user interface, sending a hot water dispensing signal to the fluidic water conduit;
i) as a function of said hot water dispensing signal, by the first heating device performing a final heating of a volume of water to be dispensed comprising the amount of preheated water reintroduced into the main branch and/or an amount of unheated water entering the main branch from the first water inlet opening to bring it to a predetermined dispensing temperature; and
j) allowing a passage of water heated to the predetermined dispensing temperature through the hot water dispensing opening.

18. The method of claim 17, wherein step i) comprises the following sub-steps:
i1) providing a temperature sensor suitable for detecting a temperature of the water at the first heating device and operatively connected to the electronic control unit;
i2) by the electronic control unit, making a comparison between the temperature detected by said temperature sensor and a minimum preheating temperature; and
i3) as a function of said comparison, performing one of the following actions:
i31) if the temperature detected is greater than or equal to said minimum preheating temperature, heating the water by the first heating device on a maximum water flow rate, to bring the water to the predetermined dispensing temperature;
i32) if the temperature detected is less than the minimum preheating temperature, heating the water by the first heating device on a water flow rate that is less than the maximum water flow rate, to bring the water to the predetermined dispensing temperature.

19. The method of claim 17, optionally comprising, after step j), actuating the method of recirculating preheated water again so as to immediately provide an amount of preheated water for a successive dispensing.

20. A coffee machine comprising a coffee dispensing unit and the dispensing group of claim 10.
